(19) United States
(12) Patent Application Publication
(10) Pub. No.: US 2015/0371410 A1
(43) Pub. Date: Dec. 24, 2015

(54) BATCH RENDERING METHOD FOR 2D VECTOR GRAPHICS PATH USING GPU

(71) Applicant: COMPANY 100, INC., Seoul (KR)

(72) Inventors: Dong-Seong HWANG, Anyang-si, Gyeonggi-do (KR); Chang-Hun KANG, Seongnam-si, Gyeonggi-do (KR)

(21) Appl. No.: 14/397,303

(22) PCT Filed: Nov. 5, 2012
(86) PCT No.: PCT/KR2012/009222

§ 371 Date: Oct. 27, 2014

(30) Foreign Application Priority Data
Apr. 27, 2012 (KR) 10-2012-0044404

(51) Int. Cl. G06T 11/00; G06T 1/00

(52) U.S. Cl. CPC G06T 11/001; G06T 1/0007

(57) ABSTRACT

The present invention relates to a batch rendering method for two-dimensional (2D) vector graphics paths using a GPU, which may enhance the program processing speed of a game or advertisement made through HTML5 technology by utilizing 2D vector graphics batch rendering using a GPU. The present invention include gathering paths requested through an API (Application Program Interface) without immediately drawing the paths, in order to draw the paths of 2D vector graphics; drawing the gathered paths on a stencil atlas; and drawing, on a screen, quadrilaterals including the stencil atlas shape corresponding to each path in order to draw the gathered paths.

### TECHNICAL FIELD

The present invention relates to a technology for enhancing the processing speed of a game program using a canvas of HTML5, and more particularly, to a batch rendering method for two-dimensional (2D) vector graphics paths using a GPU, which may enhance the program processing speed of a game or advertisement made through HTML5 technology by utilizing 2D vector graphics batch rendering using a GPU.

### BACKGROUND ART

Recently, the major IT companies such as Google, Apple, and Nokia have made a lot of effort to develop a graphic processing unit (GPU) for 2D vector graphics.

Google has GPU-accelerated Skia through OpenGL (Open Graphics Library) which is one of GPU APIs (Application Program Interfaces). Skia is a 2D vector graphics library used in the Chrome browser and the Android operating system. Recently, the Chrome browser and the Android operating system have used the technology. Apple also has

GPU-accelerated Quartz, which is a 2D vector graphics library generally used in the Cocoa framework, through OpenGL. The technology for GPG-accelerating Quartz through OpenGL is generally used in OSX Lion which is the latest OS of Apple. Nokia also has GPU-accelerated Qt, which is a 2D vector graphics library of Nokia, through OpenGL.

However, the 2D vector graphics libraries such as Skia, Quartz, and Qt unnecessarily use a CPU (Central Processing Unit) in many cases, and do not make the most of the GPU. The greatest reason is that batch rendering is not performed.

FIG. 1 illustrates 2D vector graphics rendering according to the related art.

One of the fields that make the most of GPU technology is the game engine field. It has been 15 years since games engines were researched in the industry, and methods for effectively using a GPU are publicly known. The most important thing in utilizing the GPU technology in a game engine is that as many vertexes as possible are gathered and batch-processed at a time, during a draw API call of Direct3D or OpenGL.

Most game engines, such as an unreal engine and a blender game engine which are 3D game engines, are designed to batch-process as many draw calls as possible. It is intuitive for a game engine to batch-process draw calls. That is because all objects to be drawn are determined before a game is driven. The game engine is designed to draw a main character, enemy characters, and a map by batch-processing the main character, the enemy characters, and the map, of which the respective pieces of vertex information are fixed.

Recently, 2D game engines through which a 2D game can be easily created on the mobile have been developed. The most attention has been paid to Cocos2D which is a 2D game engine for iPhone. Although Cocos2D is a 2D game engine, Cocos2D draws an actual picture through a GPU. At this time, batch processing is actively used. When drawing a screen, Cocos2D gathers pictures to be drawn in one texture through a texture atlas, and stores the gathered pictures in advance. Thus, drawing calls may be effectively gathered.

The texture atlas is a term which is generally used in graphics, and indicates gathering a plurality of pictures in one texture.

In the conventional game engine field, batch processing is actively used in order to effectively use a GPU. However, when a GPU for 2D vector graphics is implemented, batch processing may not be effectively performed. In this case, the processing speed of a program using 2D vector graphics may be slowed.

The first reason why batch processing is not effectively performed when a GPU for 2D vector graphics is implemented is that the technology for implementing a GPU for 2D vector graphics is not yet mature. The second reason is that objects to be drawn are not fixed like a game engine.

### DISCLOSURE

### Technical Problem

Accordingly, the present invention has been made in an effort to solve the problems occurring in the related art, and an object of the present invention is to provide a batch rendering method for 2D vector graphics paths using a GPU, which may enhance the program processing speed of a game or advertisement made through HTML5 technology by utilizing 2D vector graphics batch rendering using a GPU.

### Technical Solution

In order to achieve the above object, according to one aspect of the present invention, a batch rendering method for 2D vector graphics paths using a GPU may include: gathering paths requested through an API (Application Program Interface) without immediately drawing the paths, in order to draw the paths of 2D vector graphics; drawing the gathered paths on a stencil atlas; and drawing, on a screen, quadrilaterals including the stencil atlas shape corresponding to each path in order to draw the gathered paths.

### Advantageous Effects

When the batch rendering method for 2D vector graphics paths using a GPU is utilized, interactive animation of a game or advertisement made through HTML5 on the mobile can be more conveniently accelerated.

### BRIEF DESCRIPTION OF THE DRAWINGS

The above objects, and other features and advantages of the present invention will become more apparent after a reading of the following detailed description taken in conjunction with the drawings, in which:

FIG. 1 illustrates 2D vector graphics rendering according to the related art;

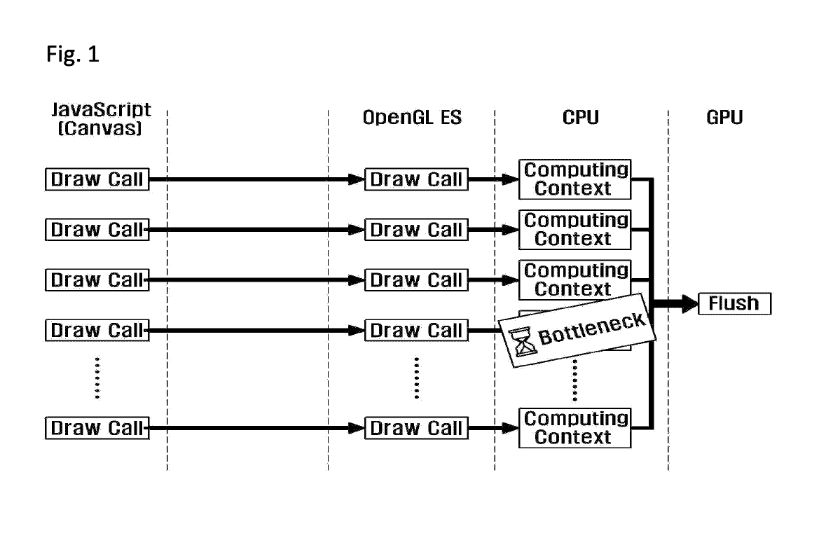

FIG. 2 illustrates the principle that 2D vector graphics rendering method using a GPU in accordance with an embodiment of the present invention is used to maximize the load of a CPU;

FIG. 3 is a flowchart illustrating a batch rendering method for 2D vector graphics paths using a GPU in accordance with an embodiment of the present invention;

FIGS. 4A and 4B are diagrams for describing that 2D vector graphics batch rendering is arranged in accordance with the embodiment of the present invention;

FIG. 5 illustrates another embodiment for drawing the shadows of 2D vector graphics paths;

FIGS. 6A to 6C are diagrams illustrating that shadows are arranged in the 2D vector graphic batch rending in accordance with the embodiment of the present invention;

FIG. 7 illustrates another embodiment for drawing paths and images of 2D vector graphics;

FIGS. 8A to 8C are diagrams for describing that paths and images are arranged together in the 2D vector graphic batch rending in accordance with the embodiment of the present invention;

FIG. 9 illustrates another embodiment for drawing paths and texts in the 2D vector graphic batch rending; and

FIGS. 10A to 10C are diagrams for describing that paths and texts are arranged together in the 2D vector graphic batch rending in accordance with the embodiment of the present invention.

### BEST MODE FOR THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

The reason that a method for implementing 2D vector graphics batch rendering using a GPU in accordance with an embodiment of the present invention exhibits better performance than a conventional method for implementing 2D vector graphics batch rendering using a CPU is to perform batch processing in accordance with the embodiment of the present invention. The present invention provides a solution to how to effectively perform batch processing when 2D vector graphics are implemented using a GPU.

The most important thing in utilizing GPU technology in a game engine is to gather as many vertexes as possible at a draw API call of Direct3D or OpenGL and batch-process the gathered vertexes. The batch process using a GPU in a game engine is publicly known in this field. For example, it is known that 150 or more graphics vertexes need to be requested for the GPU through at one draw call.

Otherwise, a bottleneck of graphic rendering may occur in the CPU instead of the GPU. The greatest reason that a bottleneck occurs in the CPU is that a GPU driver needs to perform a fixed operation regardless of the number of graphics vertexes when a drawing call is made for the GPU.

During batch rendering of 2D vector graphics using a GPU, context information of the GPU is gathered, and the result is notified to the GPU at each time. Such a repetition unnecessarily consumes the resource of the CPU. For example, drawing 100 graphic vertexes are drawn ten times, a 10 times longer time is spent than when 1,000 graphic vertexes are drawn once.

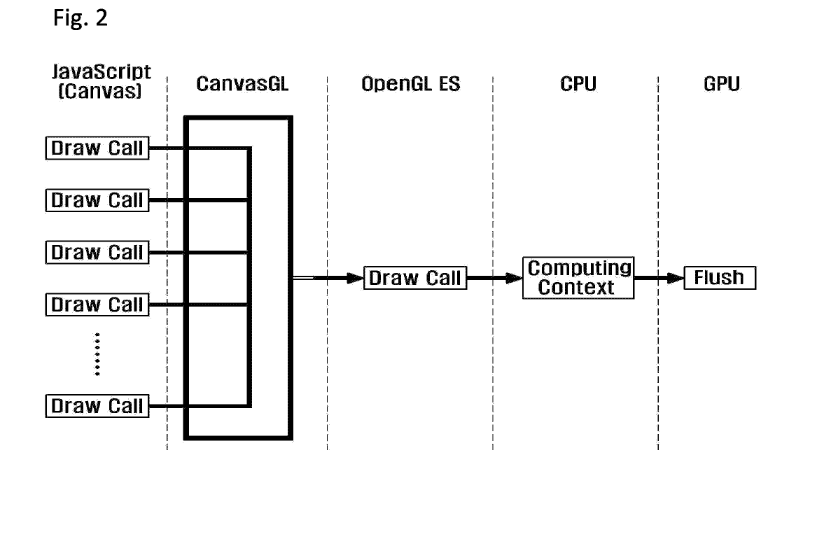

The method in accordance with the embodiment of the present invention gathers as many vertexes as possible and draws the gathered vertexes at one draw call, when various graphic shapes are drawn using 2D vector graphics. FIG. 2 illustrates the principle that 2D vector graphics rendering method using a GPU is used to maximize the load of a CPU. The 2D vector graphics rendering method using a GPU may convert an application-based game on the mobile into a game on the web as the common platform.

The reason that a 2D game engine can easily perform batch rendering is that the contents of pictures to be drawn are stored in a texture atlas. For example, when the 2D game engine draws 10 objects according to the batch rendering method, 10 quadrilaterals and information of textures to be mapped to the respective quadrilaterals are drawn at one draw call. Without the above-described texture atlas, textures corresponding to 10 images need to be bound, and a drawing operation needs to be performed 10 times. Thus, 10 draw calls are required. However, when the texture atlas is provided, the texture does not need to be checked each time. Thus, the texture may be bound once, and 10 quadrilaterals may be drawn at one draw call.

Such a method may be applied to path rendering of 2D vector graphics using a GPU. In this case, while the pictures to be drawn by the 2D game engine are stored in the texture atlas, the shape of a path to be drawn by 2D vector graphics is stored in a stencil atlas.

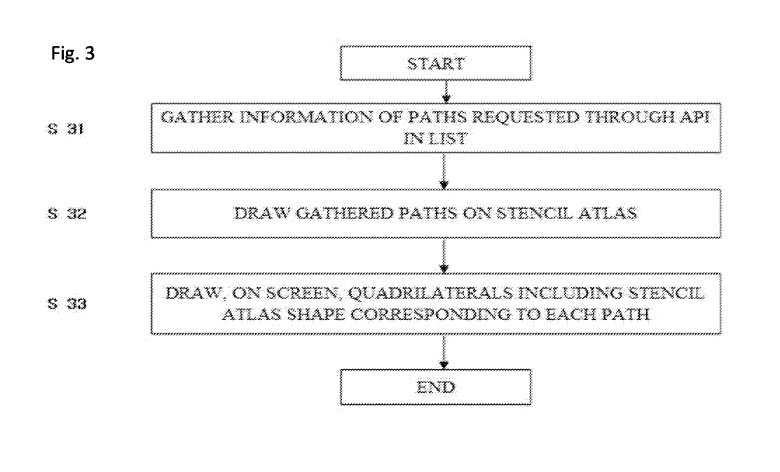

FIG. 3 illustrates a batch rendering method for 2D vector graphics paths using a GPU in accordance with an embodiment of the present invention. As illustrated in FIG. 3, the batch rending method includes a first step S31 of gathering (or storing) information of paths to be drawn in a list; a second step S32 of making a stencil atlas to draw paths on divided regions of one texture; and a third step S33 of drawing a picture of the stencil atlas on a screen.

At the first step S31 of gathering (or storing) the information of paths to be drawn in the list, the following operations are performed. First, graphics vertexes are generated such that the GPU draws a path. When the path has a curved line, a plurality of straight lines are interpolated to generate graphics vertexes. The generated graphics vertexes are stored in the list. At this time, the generated vertexes are drawn through a triangle fan at the second step S32. Then, the size of a quadrilateral, which is large enough to include all graphic vertexes of the path, is calculated. The calculated quadrilateral size is allocated from the stencil atlas. The stencil atlas determines the coordinates of a rectangle to which a quadrilateral having a requested size can be allocated through a 2D rectangle bin packing algorithm. Finally, when the path is drawn on the screen at the third step S33, the shape of the stencil atlas is texture-mapped to draw a quadrilateral on the screen. For this operation, the coordinates and size of the quadrilateral to be drawn on the screen and the texture coordinates and size required for texture mapping are stored in the list.

At the second step S32 of making the stencil atlas through a process of drawing paths on divided regions of one texture, the following operations are performed.

As described above, at the first step, the graphics vertexes for drawing a path are calculated, and the coordinates and size of a quadrilateral are calculated to determine where to draw the path. At the second step, the calculated information is used to set a stencil operation to an exclusive OR (XOR) operation, and the graphics vertexes are drawn through the triangle fan which is one of methods for drawing vertexes of a GPU.

When the graphics vertexes are drawn in such a manner, a picture is drawn to satisfy an even/odd fill method of 2D vector graphics. Both of a concave path and a convex path satisfy the even/odd fill method. When a path is intended to be drawn through a nonzero fill method, the setting of the stencil operation may be changed. When a stencil operation for a clockwise polygon is set to an increasing function Incr and a stencil operation for a counterclockwise polygon is set to a decreasing function Decr, a path is drawn to satisfy the nonzero fill method.

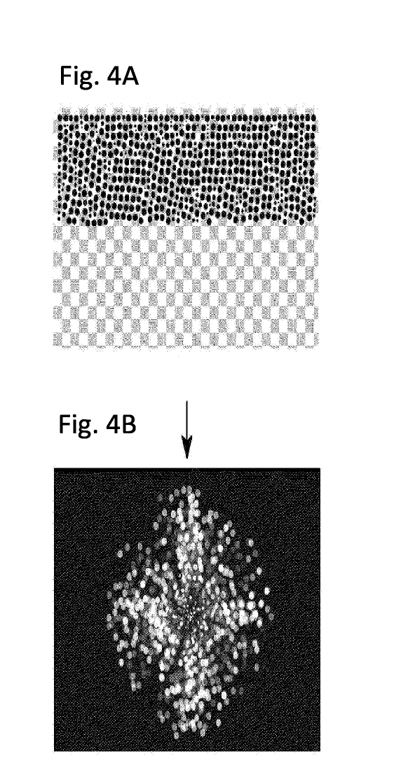

FIG. 4A illustrates that a stencil atlas is made by drawing paths on divided regions of one texture. Referring to FIG. 4A, path information is used to draw 600 circles on 600 quadrilateral regions at a time.

At the third step S33 of drawing the picture of the stencil atlas on the screen, the following operations are performed.

As described above, at the first step, the coordinates and size of the quadrilateral of paths to be drawn on the screen and the coordinates and size of the texture for texture-mapping the stencil atlas are stored in a list. At the third step, the information stored in the list is used to draw quadrilaterals of all paths at one draw call.

FIG. 4B illustrates that the picture of the stencil atlas is drawn on the screen. Referring to FIG. 4B, 600 quadrilaterals are drawn and texture-mapped to the stencil atlas, and 600 circles are finally drawn on the screen.

In the 2D vector graphics, however, an API for drawing a shadow exists. When a shadow needs to be drawn in case where a certain path is drawn, the following operation may be added to the second step S32 so as to achieve an arrangement.

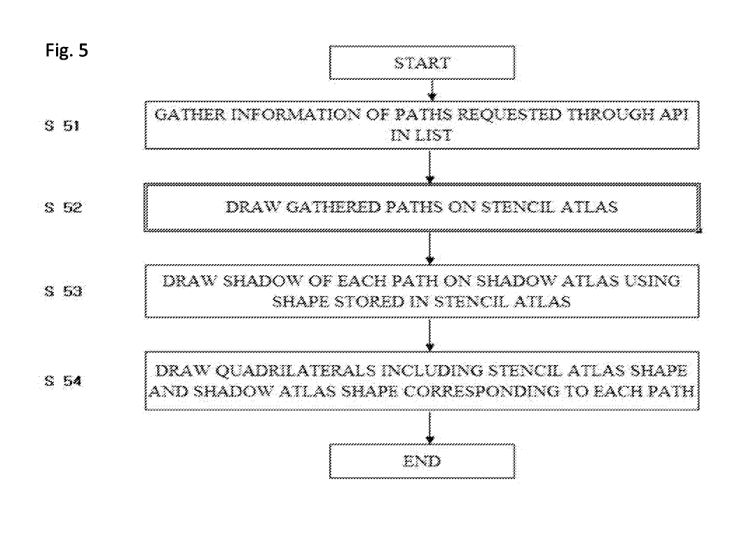

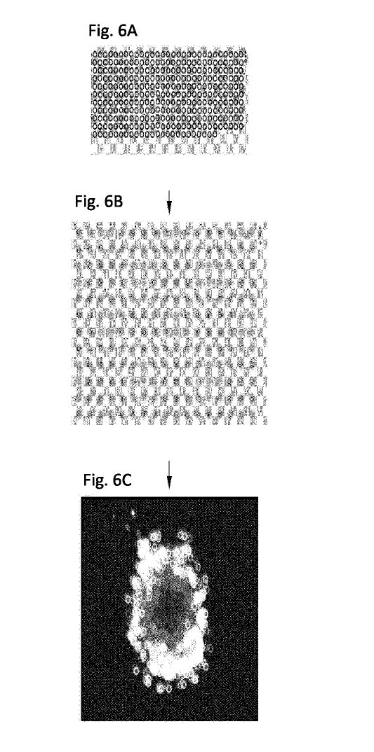

Referring to FIGS. 5 and 6, an embodiment of the present invention will be described as follows.

At this time, a shadow atlas is required to store the shape of a shadow, like the stencil atlas to store the shape of a path.

At a first step S51, information of paths to be drawn is gathered in a list. At a second step S52, a stencil atlas for drawing paths on divided regions of one texture is made. At a third step S53, the shadow of each path is drawn on the shadow atlas using the shape stored in the stencil atlas. At a fourth step S54, the shapes of the stencil atlas and the shadow atlas are drawn on the screen.

FIGS. 6A to 6C illustrate the case in which a shadow needs to be drawn when a certain path is drawn. FIG. 6A illustrates that path information is used to draw 600 circles on 600 quadrilateral regions at a time as illustrated in FIG. 4A. FIG. 6B illustrates that stencil atlas is used to draw 600 shadows on 600 quadrilateral regions at a time. FIG. 6C illustrates that 1,200 quadrilaterals are drawn. Among the 1,200 quadrilaterals, 600 quadrilaterals are texture-mapped to the stencil atlas, and the other 600 quadrilaterals are texture-mapped to the shadow atlas. Finally, 600 circles and 600 shadows are drawn on the screen.

The 2D vector graphics are drawn as images and texts as well as paths. FIGS. 3 and 5 are flowcharts illustrating how to arrange paths. In order to make the most of the GPU, images and texts need to be arranged even when the images and texts are drawn together with the paths.

2D game engines arrange images and draw the arranged images. When the above-described texture atlas is used, images may be arranged and drawn. The texture atlas is a texture in which images drawn on divided regions are stored. In the above descriptions, only paths may be arranged, or only images may be arranged. However, even when paths and images are mixed and drawn, the paths and the images may be arranged.

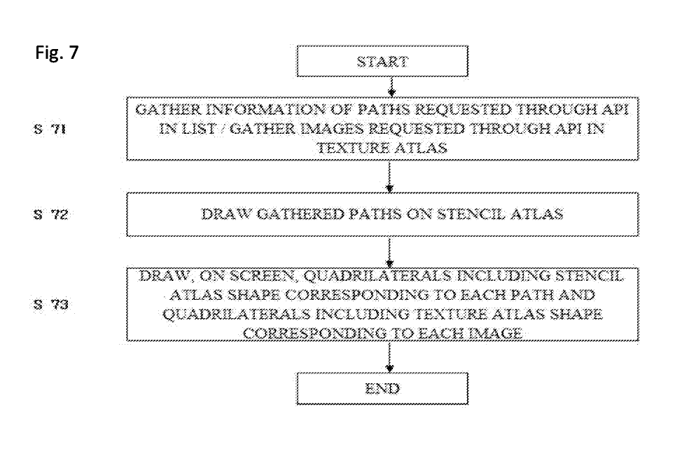

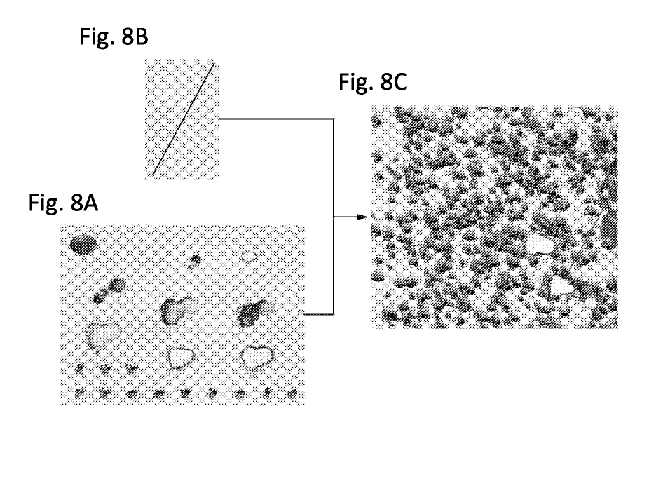

According to the embodiment of the present invention, the path and images may be organically arranged. This will be described as follows with reference to FIGS. 7 and 8.

At a first step S71, information of paths to be drawn is gathered in a list, and images to be drawn are gathered in the texture atlas. FIG. 8A illustrates that images are stored in divided regions of the texture atlas.

At a second step S72, a stencil atlas for drawing paths on divided regions of one texture is made. FIG. 8B illustrates the above-described stencil atlas.

At a third step S73, the picture of the stencil atlas and the picture of the texture atlas are drawn on the screen. FIG. 8C illustrates that the images stored in the texture atlas are used to drawn all images at a time.

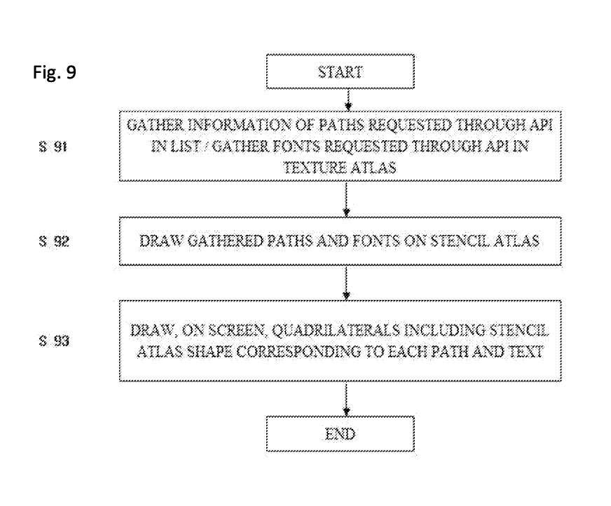

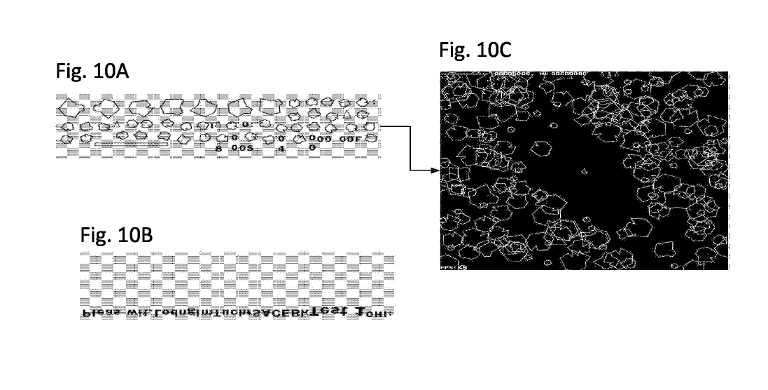

Hereafter, a method for arranging paths and texts when the paths and texts are drawn together according to the embodiment of the present invention will be described with reference to FIGS. 9 and 10.

In general, when 2D vector graphics using a GPU are implemented, paths and images are not arranged, but texts are arranged in case where the texts are drawn. For example, Skia of Google, Quartz2D of Apple, and Qt of Nokia arrange the texts in the same manner.

The basic method for drawing texts according to the embodiment of the present invention is similar to the conventional method. However, the following steps are newly added to arrange texts and paths together.

At a first step S91, information of paths to be drawn is gathered in a list, and texts to be drawn (fonts requested through an API) are gathered in the texture atlas, in addition to the first step S31 of FIG. 3. FIG. 10A illustrates an example in which fonts are stored in the texture atlas at the first step S91. Referring to FIG. 10A, the fonts are stored in divided regions of the texture atlas. The texture atlas indicates a texture which stores images drawn on divided regions thereof.

At a step S92, the gathered paths and the fonts drawn in the texture atlas are stored in the stencil atlas. At this time, the graphics vertexes for the shape of the paths are drawn in the stencil atlas through the stencil operation, and the picture of the texture atlas is texture-copied to store the shape of the text in the stencil atlas. FIG. 10B illustrates the stencil atlas at the second step S92.

At a third step S93, the pictures of the paths and fonts stored in the stencil atlas are drawn on the screen. FIG. 10C illustrates that the paths and fonts are drawn on the screen as the shape stored in the stencil atlas at the third step S93.

Through the series of steps S91 to S93, the paths and texts may be organically combined.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. A batch rendering method for 2D vector graphics paths using a GPU, comprising:
(a) gathering paths requested through an API (Application Program Interface) without immediately drawing the paths, in order to draw the paths of 2D vector graphics;
(b) drawing the gathered paths on a stencil atlas; and
(c) drawing, on a screen, quadrilaterals including the stencil atlas shape corresponding to each path in order to draw the gathered paths.

2. The batch rendering method of claim 1, wherein the stencil atlas is a space which allocates quadrilaterals capable of including the respective paths through a two-dimensional rectangle bin packing algorithm, and the paths are drawn and stored in the respective quadrilateral regions through a stencil operation.

3. The batch rendering method of claim 1, further comprising, after the step (b):
drawing the shadow of each path on a shadow atlas using the shape stored in the stencil atlas; and
drawing, on the screen, quadrilaterals including the stencil atlas shape and the shadow atlas shape corresponding to each path, in order to the gathered paths and shadows,
wherein when the paths of the 2D vector graphics are drawn, the shadows are drawn together.

4. The batch rendering method of claim 3, wherein the shadow atlas is a texture which stores the shadows of paths drawn on divided regions thereof.

5. The batch rendering method of claim 1, wherein the step (a) comprises drawing images requested through the API on a texture atlas,
the step (c) comprises additionally drawing, on the screen, quadrilaterals including the texture atlas shape corresponding to each image as well as the quadrilaterals including the stencil atlas shape, and
the images of the 2D vector graphics are drawn together with the paths.

6. The batch rendering method of claim 5, wherein the texture atlas is a texture which stores images drawn on divided regions thereof.

7. The batch rendering method of claim 1, wherein the step (a) comprises drawing fonts requested through the API on a texture atlas,
the step (b) comprises drawing, on the stencil atlas, the fonts drawn on the texture atlas as well as the gathered paths,
the step (c) comprises drawing, on the screen, quadrilaterals including stencil atlas shapes corresponding to texts as well as the quadrilaterals including the stencil atlas shape corresponding to each path, in order to draw the gathered paths, and
the texts of the 2D vector graphics are drawn together with the paths.
